(19) United States
(12) Patent Application Publication
(10) Pub. No.: US 2009/0120506 A1
(43) Pub. Date: May 14, 2009

(54) Automated plant watering system and method

(76) Inventor: David Hoch, Belmont, MA (US)

Correspondence Address: Richman and Associates, PO Box 3333, La Jolla, CA, 92038-3333, US

(21) Appl. No.: 11/804,641

(22) Filed: May 17, 2007

Related U.S. Application Data
(60) Provisional application No. 60/801,544, filed on May 17, 2006.

(51) Int. Cl. F16K 17/36

(52) U.S. Cl. 137/78.2

(57) ABSTRACT

An automated watering controller (“WC”) that includes a ground moisture sensor, rain sensor, sound transducer, and program button. The controller may include a solar cell window 26 and a lawn treatment or fertilizer pill compartment 24. The controller may also include an LED indicator ring 36, time of day slider 34, and amount of moisture selector 32. The WC may also automatically determine the time of day, latitude, rain fall level and intensity, sun intensity, and other environmental attributes.

### CROSS-REFERENCE TO RELATED APPLICATIONS

This application is related to U.S. Provisional Application 60/801,544, Attorney Docket DH004US1, filed May 17, 2006, and entitled “Automated Plant Watering System and Method”, which is incorporated by reference herein.

### BACKGROUND

1. Field of the Invention

The invention relates generally to plant watering systems and methods, and more particularly, to automated plant watering systems and methods.

2. Description of Related Art

Many automated plant watering systems and methods are completely automated and require a user to adjust the system to account for many variables. The present invention provides a system and method that may automatically modify watering cycles as function of many variables including environmental changes and factors such as sun intensity, duration, rain fall, soil density/type, geographical location, and plant requirements.

### SUMMARY OF THE INVENTION

The present invention includes an automated watering controller that includes a ground moisture sensor, rain sensor, sound transducer, and program button. The WC may also include a solar cell window 26 and a lawn treatment or fertilizer pill compartment 24. The invention may also include an LED indicator ring 36, time of day slider 34, and amount of moisture selector 32. In an embodiment the WC may automatically determine the time of day, latitude, rain fall level and intensity, sun intensity, and other environmental attributes.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 is an isometric diagram of a watering controller (“WC”) in accordance with an embodiment of the present invention;

FIG. 2 is an illustration of a watering architecture including watering controllers shown in FIG. 1;

FIG. 3 illustrates a WC of the present invention in functional block diagram format; and

FIG. 4 illustrates an algorithm for a WC in accordance with the present invention in flowchart format.

### DETAILED DESCRIPTION

Throughout this description, embodiments and variations are described for the purpose of illustrating uses and implementations of the invention. The illustrative description should be understood as presenting examples of the invention, rather than as limiting the scope of the invention.

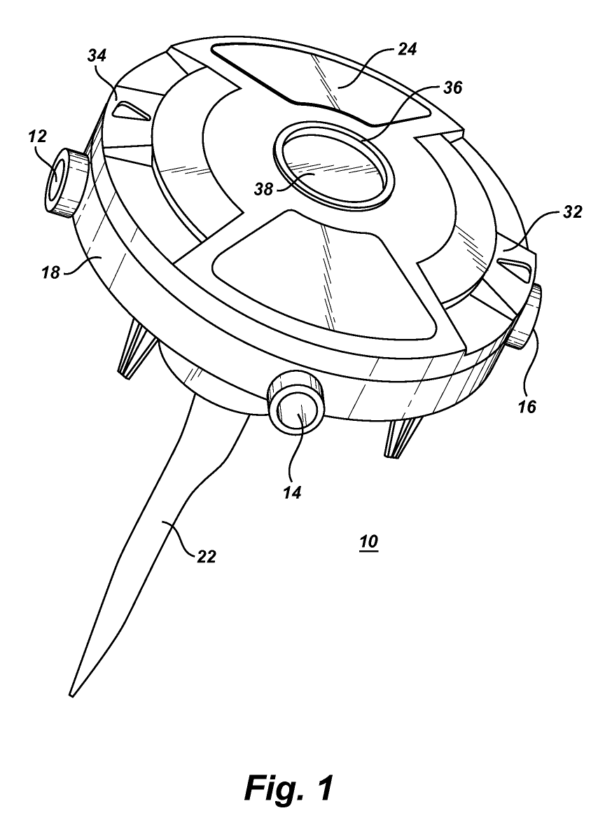

FIG. 1 is an isometric diagram of a watering controller (“WC”) 10 in accordance with an embodiment of the present invention. The watering controller 10 includes a main body 18 and a moisture and ground temperature probe 22. The main body 18 includes three water connections 12, 14, and 16. In an embodiment the water connections may include a water inlet 12, a switcher or controlled water outlet 14, and non-switched outlet 16. The main body also includes a solar cell window 26, lawn treatment or fertilizer pill compartment 24, time of day slider 34, amount of moisture selector 32, LED indicator ring 36, and a combination rain sensor, sound transducer, program button 38.

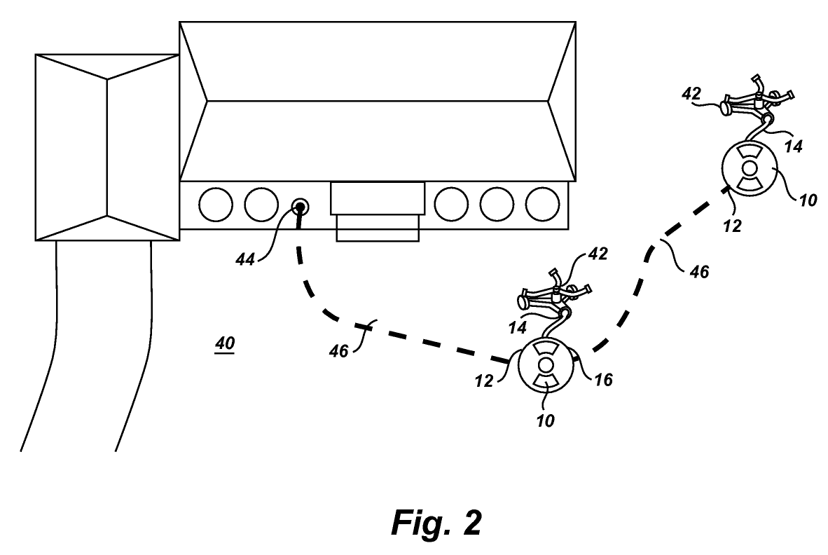

FIG. 2 is an illustration of a watering architecture 40 including several watering controllers 10 shown in FIG. 1. The architecture 40 includes two WC 10, two sprinklers 42, hose connectors 46, and water source, spigot 44. In this embodiment a first WC 10 is coupled to a water source (spigot) 44 via a hose 46 coupled to its water inlet 12. A first sprinkler 42 is coupled to the WC 10 switched or controlled water outlet 14. The first WC 10 is then coupled to the second WC 10 via another hose 46, the hose 46 coupled to the first WC 10 non-switched outlet 16 and the second WC 10 water inlet 12. The second WC 10 is then coupled to the sprinkler 42 via the second WC 10 switched water outlet 14. In an embodiment a WC 10 may include a plurality of separately controlled water switched outlets. The WC 10 may enable operation of a single water switched outlet 14 to maintain a desired flow rate or outlet pressure. The WC 10 may also monitor the flow rate or outlet pressure and limit the operation of one or more water switched outlets 14 accordingly.

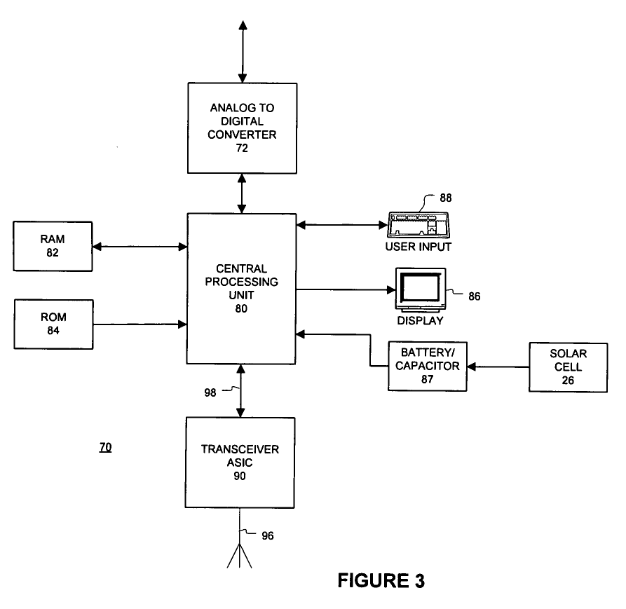

FIG. 3 illustrates a WC 10 of the present invention in functional block diagram format. The WC 10 includes a central processing unit (“CPU”) 80, random access memory (“RAM”) 82, read only memory (“ROM”) 84, a display 86, a user input device 88, a transceiver application specific integrated circuit (“ASIC”) 90, Analog to Digital Converter (A/D) 72, and an antenna 96. The ROM 84 is coupled to the CPU 80 and may store the program instructions to be executed by the CPU 80. The RAM 82 is coupled to the CPU 80 and may store temporary program data. The user-input device 88 is an input device such as the program button 38. The display 86 is an output device such as an LED 36 indicator that enables a user to read data generated by the CPU 80. The A/D 72 may be used to communicate with the rain sensor, sound transducer, program button 38. The WC 10 may include a battery or capacitor 87 coupled to the CPU 80 and solar cell 26. The solar cell window 26 may include one or more photovoltaic cells that convert photons into electrical energy. The CPU 80 may monitor the energy generated by the solar cells and the battery or capacitor 87 to determine the solar intensity and duration during any time interval.

The transceiver ASIC 90 includes the instruction set necessary to communicate data and voice signals over a WC network, i.e., the WC may be able to communicate with each other to better determine environmental attributes. The ASIC 90 is coupled to an antenna 96 for communicating signals with the WC network 40. When a data signal is received by the transceiver ASIC 90, the data may be transferred to the CPU 80 via the serial bus 98. The data can include applications to be executed via the CPU 80. For example, a user may be able to update the instruction set of a WC as changes to the code or firmware are needed. A single WC may then propagate the update to other designated WCs 10.

In an embodiment the moisture and ground temperature probe 22 may include a number of different sensors, capable of sensing resistance, capacitance, inductance, electromagnetic propagation delay and other properties of the soil. The rain sensor, sound transducer 38 may monitor humidity, wind, amount of rain, size and force of rain drops, evaporation rate, and temperature during the day or time interval, so it may determine the amount of water to be passed via one or more switched outlets 14. The solar cell window may also be used to determine the amount of sun, and the change of sunlight and darkness to empirically determine the time of day, the actual calendar date, and the latitude of where the device is placed on the planet. Devices can be connected in Series using a “Pass through” system (inlet 12 and outlet pass through 16).

Devices may also communicate to each other using the conductance of the water inside the high pressure side of the hoses (between the inlet 12 and outlet pass through 16, such as between the WCs 10 in FIG. 2). In an embodiment the device is made from polycarbonate, that is hermetically Welded and sealed. In an embodiment knob positions of the time of day slider 34 and amount of moisture selector 32 are determined by fixed magnets that change position over low-cost inductive sensors inside the device in a totally “touch-less” method. The WC 10 also has a chamber/compartment 24 where a dissolvable “pill” can be inserted. During watering, controlled amounts of the pill may dissolve into the water being. delivered to a nearby area. The pill may contain fertilizer nutrients and/or insecticides that coat the plant leaves during watering each day.

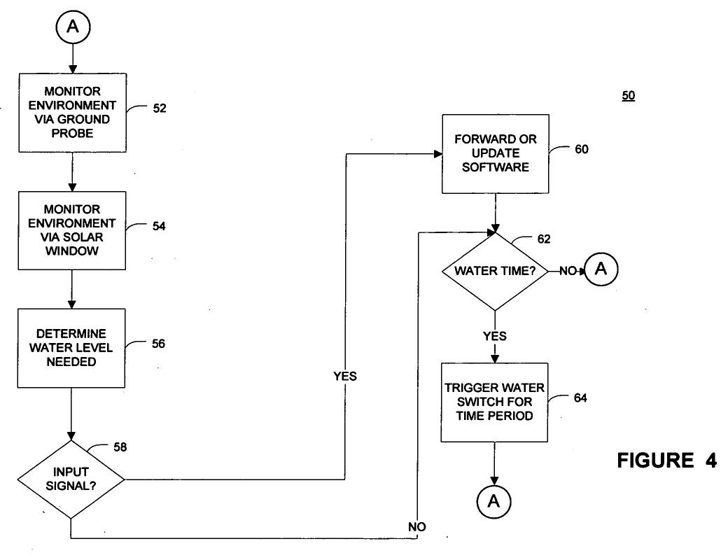

In an embodiment the WC 10 may be used in “sensor only” mode, with water hoses attached (employing the algorithm 70 shown in FIG. 4). In this embodiment soil moisture level data (steps 52, 54) and other data is collected and transmitted in a wired or wireless manner to another device (steps 58, 60). In this case, a matrix of devices can be used for crop or flood monitoring. The WC 10 may also detect the amount of water flow through it and can calculate the-current flow of water in gallons/min (step 56). It also can measure the total amount of water used in gallons. The algorithm 70 may trigger one or more switch outlets

It is noted that the hoses 46 may be a water hose that may be pressed into the soil, so that a lawn mover can mow above the hoses. Hoses 46 can be placed just under the grass using a grass slitting machine, or above grass using a standard hose. Also, devices have a “Pass through” connection, so that devices can be connected in SERIES as shown in FIG. 2.

In an embodiment to employ the WC 10, a user may plug the WC 10 into the ground. In an embodiment the time of day slider 34 may include DUSK, DAWN, NIGHT or DAY. The user may also how moist the lawn or garden (plants) should be maintained at by sliding the moisture switch 32 where the moisture settings may include WET, VERY MOIST, MOIST, or MOIST-DRY.

As noted WCs 10 may communicate with each other using the actual water hose 46 as a communication channel where the devices send an electrical signal through the water in the hose itself The WCs 10 may create “Zones” so that that they do not water all at the same time which under low-pressure situations is not possible. In addition, the WCs 10 may communicate with each other using wireless transceivers. The WCs 10 may use a proprietary communications protocol that allows them to step and repeat data to adjacent devices. The protocol may enable a WC 10 to communicate with another WC 10 that is a mile away, with a transmit range of 100 meters via intermediate WCs.

In an embodiment the WC 10 may programmed to switch water outlets only certain days is done by setting the slide switches in 1 of 16 possible positions and pressing the center button that latches in a particular watering day restriction. In an embodiment the device blinks with a soft blue light periodically at night to confirm operation status. In an embodiment the rain sensor, sound transducer, program button 38 is a single piezo transducer that is used to sense when it is raining, the size of the drops, vibration in the surrounding soil, wind, amount of total rainfall, output an audio sound, and input a touch from an external user. The WC 10 may also include sensors that measure temp of the air and soil, wind velocity, humidity, amount and strength of sunshine (light).

While this invention has been described in terms of a best mode for achieving this invention's objectives, it will be appreciated by those skilled in the art that variations may be accomplished in view of these teachings without deviating from the spirit or scope of the present invention. For example, the present invention may be implemented using any combination of computer programming software, firmware or hardware. As a preparatory step to practicing the invention or constructing an apparatus according to the invention, the computer programming code (whether software or firmware) according to the invention will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the computer programming code is used by either executing the code directly from the storage device, by copying the code from the storage device into another storage device such as a hard disk, RAM, etc. or by transmitting the code on a network for remote execution.

What is claimed is:

1. An automated watering apparatus comprising a single housing, the housing including:
a water inlet;
a switched water outlet;
one of a rain sensor and a wind sensor;
a solar cell;
an energy cell coupled to the solar cell; and
a processor coupled to the switched water outlet, one of the rain sensor and the wind sensor and one of solar cell and the energy cell, wherein the processor controls the water outlet as a function of the one of the rain sensor and the wind sensor and one of solar cell and the energy cell.

2. The automated watering apparatus of claim 1, the housing further including a ground spike, the spike including one of a moisture sensor and a temperature sensor, and wherein the processor is coupled to one of a moisture sensor and a temperature sensor and the processor controls the water outlet as a function of the one of the rain sensor, the wind sensor and one of solar cell and the energy cell, and one of a moisture sensor and a temperature sensor.

3. The automated watering apparatus of claim 1, wherein the one of a rain sensor and a wind sensor includes piezo transducer.

4. The automated watering apparatus of claim 1, the housing further comprising a fertilizer compartment in communication with switched water outlet.

5. The automated watering apparatus of claim 4, the housing further comprising a non-switched water outlet.

6. The automated watering apparatus of claim 4, the housing further including a time of day slider.

7. The automated watering apparatus of claim 4, the housing further including a moisture level slider mechanism.

8. The automated watering apparatus of claim 7, wherein the moisture level mechanism includes a fixed magnet and an inductor.

9. An automated watering system comprising:
a first automated watering apparatus; and
a second automated watering apparatus; wherein the first automated watering apparatus and the second automated watering apparatus each includes a single housing, the housing including:
a water inlet;
a switched water outlet;
a non-switched water outlet;
one of a rain sensor and a wind sensor;
a solar cell;
an energy cell coupled to the solar cell; and
a processor coupled to the switched water outlet, one of the rain sensor and the wind sensor and one of solar cell and the energy cell, wherein the processor controls the water outlet as a function of the one of the rain sensor and the wind sensor and one of solar cell and the energy cell; and
a water connector coupled to the first automated watering apparatus non-switched water outlet and the second automated watering apparatus water inlet.

10. The automated watering apparatus of claim 9, the housing further including a ground spike, the spike including one of a moisture sensor and a temperature sensor, and wherein the processor is coupled to one of a moisture sensor and a temperature sensor and the processor controls the water outlet as a function of the one of the rain sensor, the wind sensor and one of solar cell and the energy cell, and one of a moisture sensor and a temperature sensor.

11. The automated watering apparatus of claim 9, wherein the one of a rain sensor and a wind sensor includes piezo transducer.

12. The automated watering apparatus of claim 9, the housing further comprising a fertilizer compartment in communication with switched water outlet.

13. The automated watering apparatus of claim 12, the housing further including a time of day slider.

14. The automated watering apparatus of claim 13, the housing further including a moisture level slider mechanism.

15. The automated watering apparatus of claim 14, wherein the moisture level mechanism includes a fixed magnet and an inductor.
